(19) United States
(12) Patent Application Publication
(10) Pub. No.: US 2026/0056658 A1
(43) Pub. Date: Feb. 26, 2026

(54) CONTROL DEVICE, MEMORY DEVICE AND MEMORY SYSTEM

(71) Applicant: SK hynix Inc., Icheon-si (KR)

(72) Inventors: Young Jo KIM, Icheon-si (KR); Dong Hun JEONG, Icheon-si (KR); Bo Seok JEONG, Icheon-si (KR)

(21) Appl. No.: 19/000,864

(22) Filed: Dec. 24, 2024

(30) Foreign Application Priority Data
Aug. 20, 2024 (KR) 10-2024-0110892

(51) Int. Cl. G06F 3/06

(52) U.S. Cl. CPC G06F 3/0608; G06F 3/0659; G06F 3/0673

(57) ABSTRACT

Data to be stored in a memory is compressed by units of a predetermined size, and compression format data is configured only with sequences, each including information on a non-repetitive portion and a repetitive portion in the data, and each of a compression operation and a decompression operation is processed in parallel. Therefore, the storage space of the memory may be efficiently used, and delays due to compression and decompression operations on the data to be stored in the memory may be reduced, whereby it is possible to improve the operational performance of the memory.

### CROSS-REFERENCE TO RELATED APPLICATION

The present application claims priority under 35 U.S.C. § 119(a) to Korean Patent Application No. 10-2024-0110892 filed in the Korean Intellectual Property Office on Aug. 20, 2024, which is incorporated herein by reference in its entirety.

### BACKGROUND

### 1. Technical Field

Embodiments of the present disclosure relate to a control device, a memory device and a memory system.

### 2. Related Art

A memory system may include at least one memory that stores data. The memory system may include a controller that controls the operation of the at least one memory or controls the overall operations of the memory system.

Depending on the type of memory system, a memory included in the memory system may be volatile memory or nonvolatile memory. Alternatively, one part of the memory included in the memory system may be volatile memory, and the other part may be nonvolatile memory.

In order to increase the amount of data that can be stored in the memory system, due to the limited capacity of the memory included in the memory system, the controller or the like included in the memory system may compress data and store compressed data in the memory. The storage space of the memory may be efficiently managed, but delays may occur due to compression of data and decompression of compressed data.

### SUMMARY

Various embodiments of the present disclosure are directed to providing measures capable of improving the performance of a memory system that stores compressed data in a way to efficiently perform compression of received input data and decompression of the compressed data.

In an embodiment, a memory system may include: at least one memory; and a controller configured to receive input data from an external device, compress at least a part of the input data to generate compressed data including a plurality of sequences, and to store the compressed data in the at least one memory, wherein each of the plurality of sequences includes token bits that correspond to a first data portion and a second data portion, the token bits including first token bits indicating a length of the first data portion and second token bits indicating a length of the second data portion; offset bits that are consecutive to the token bits and include start position bits indicating a start position of repetitive data corresponding to the second data portion; and the first data portion, which is positioned next the offset bits.

In an embodiment, a control device may include: a first controller configured to communicate with a host device; a second controller configured to communicate with a memory device; and a compression control circuit configured to compress at least a part of input data received from the host device to generate compressed data to be stored in the memory device, the compressed data including a plurality of sequences, wherein each of the plurality of sequences includes first token bits that correspond to a first data portion and indicate a length of the first data portion; second token bits that correspond to a second data portion and indicate a length of the second data portion; first auxiliary upper bits that are used to indicate the length of the first data portion; start position bits that indicate a start position of repetitive data corresponding to the second data portion; and the first data portion, which is located next the start position bits.

In an embodiment, a memory device may include: a first storage region where first input data received from a host device is stored in an uncompressed state; and a second storage region where compressed data generated as second input data received from the host device is compressed is stored, wherein the compressed data includes a plurality of sequences, and wherein each of the plurality of sequences includes first token bits that indicate a length of a first data portion; second token bits that indicate a length of a second data portion; and start position bits that indicate a start position of repetitive data corresponding to the second data portion and the first data portion, and the start position bits are located between the second token bits and the first data portion.

According to the embodiments of the present disclosure, it is possible to provide a memory system in which the efficiency of a compression operation is improved in a memory system by reducing delays that occur in the course of compressing input data received from the outside or decompressing compressed data, and operational performance is improved by increasing the storage efficiency of the memory system.

### BRIEF DESCRIPTION OF THE DRAWINGS

FIG. 1 is a diagram illustrating a schematic configuration of a memory system according to embodiments of the present disclosure.

FIG. 2 is a diagram illustrating a scheme for storing compressed data in a memory included in a memory system according to an embodiment of the present disclosure.

FIGS. 3A to 3E are diagrams illustrating examples of a format of compressed data stored in a memory of a memory system according to an embodiment of the present disclosure.

FIG. 4 is a diagram illustrating an example of a configuration of a controller included in a memory system according to an embodiment of the present disclosure.

FIGS. 5 to 7 are diagrams illustrating examples of the structure of compression units included in controllers according to embodiments of the present disclosure.

FIGS. 8 to 10 are diagrams illustrating an example of the structure of a decompression unit included in a controller according to an embodiment of the present disclosure.

FIG. 11 is a diagram illustrating an example of a method in which a memory system compresses input data to generate compressed data according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly”or “immediately”is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may”fully encompasses all the meanings of the term “can”.

Hereinafter, various embodiments of the present disclosure will be described in detail with reference to accompanying drawings.

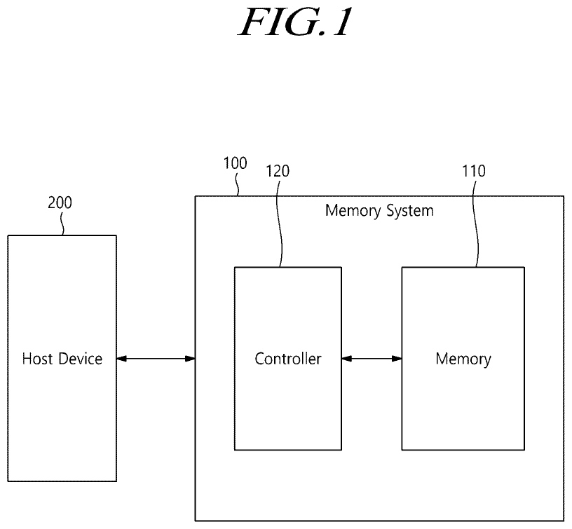

FIG. 1 is a diagram illustrating a schematic configuration of a memory system according to embodiments of the present disclosure.

Referring to FIG. 1, a memory system 100 may include at least one memory 110. In the present specification, the memory 110 or the memory system 100 may also be referred to as a memory device. The memory system 100 may include a controller 120, which controls the at least one memory 110. In the present specification, the controller 120 may also be referred to as a control device.

The memory 110 may be, for example, volatile memory such as DRAM, SDRAM, DDR SDRAM and LPDDR SDRAM, but the memory 110 according to the embodiments of the present disclosure is not limited thereto. The memory 110 may be nonvolatile memory such as NAND flash memory, 3D NAND flash memory and NOR flash memory. Some parts of the memory 110 included in the memory system 100 may be volatile memory, and other parts may be nonvolatile memory.

The memory 110 may be one of various types of memory such as resistive RAM, phase change memory, magnetoresistive memory, ferroelectric memory and spin transfer torque memory. The memory 110 may be processing-in-memory, which includes a calculation function or a data processing function. A logic circuit that performs a calculation function and so on may be disposed inside the memory 110, or a memory cell array of the memory 110 may be used for a calculation function.

The controller 120 may control the operation of the memory 110 on the basis of a command received from an external device or an internal command. For example, the controller 120 may control an operation of writing data to the memory 110 or reading data written to the memory 110. Alternatively, the controller 120 may be disposed separately from a memory controller that directly controls the write/read operation of the memory 110, and thereby, may control the memory 110 or perform processing or management on data stored in the memory 110.

The controller 120 may control the operation of the memory 110 while communicating with a device external to the memory system 100. The memory system 100 may be, for example, a device that operates while communicating with an external device on the basis of the Compute Express Link (CXL) standard, and the controller 120 may perform control on the memory 110 while communicating with the external device according to the CXL standard. In this case, the controller 120 may also be referred to as a CXL controller by being distinguished from the aforementioned memory controller. Embodiments of the present disclosure may also be applied to a memory system 100 that communicates with an external device according to another interface, such as PCIe, other than the CXL standard.

The controller 120 may control the operation of the memory 110 according to a command and data received from a host device 200 located outside the memory system 100.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device which provides a 2D or 3D virtual reality image or augmented reality image. In addition to the examples described above, the host device 200 may be any one of various electronic devices which require the memory system 100 capable of storing data for data processing.

The host device 200 may include at least one operating system. The operating system may manage and control overall functions and operations of the host device 200, and may control an interoperation between the host device 200 and the memory system 100. The operating system may be classified into a general operating system and a mobile operating system depending on the mobility of the host device 200.

The host device 200 and the controller 120 may be devices that are separated from each other. In some embodiments, the controller 120 and the host device 200 may be implemented by being incorporated as one device. For example, the function of the controller 120 may be implemented by being included in the host device 200, and the memory system 100 may include only a memory controller that directly controls the operation of the memory 110. In the following, for the sake of convenience in explanation, examples describe a controller 120 disposed in the memory system 100 separately from the host device 200, but embodiments of the present disclosure are not limited thereto.

In addition to the functions described above, in order to increase the storage efficiency of the memory system 100, the controller 120 may control an operation of compressing data received from the host device 200 and storing compressed data in the memory 110. The controller 120 may compress at least a part of data received from the host device 200 and store compressed data in the memory 110, and may also decompress data stored in the memory 110 and provide decompressed data to the host device 200.

Schemes in which the controller 120 compresses data and schemes in which the controller 120 stores compressed data in the memory 110 may be vary. In order to increase data compression efficiency for data to be stored in the memory 110 and to reduce delay due to a compression operation and a decompression operation, the controller 120 may perform compression or decompression according to a set format and process.

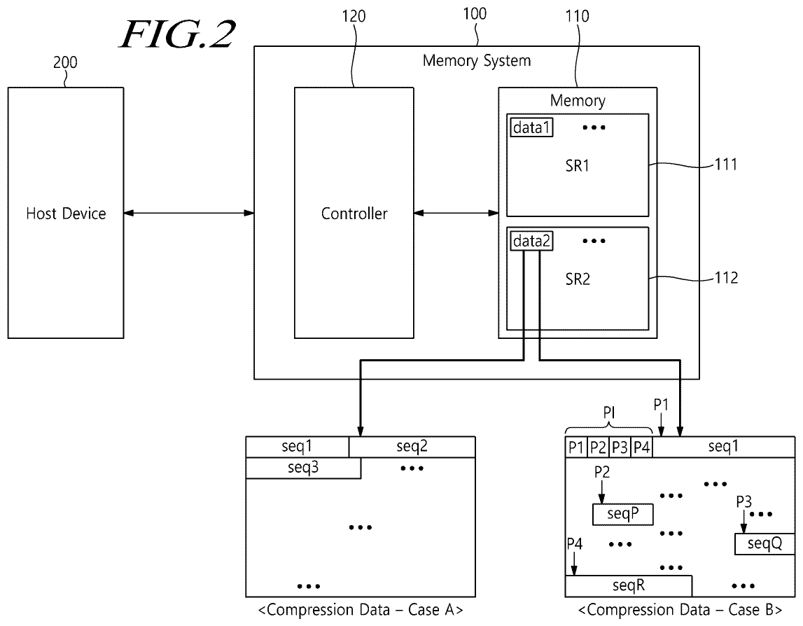

FIG. 2 is a diagram illustrating a scheme for storing compressed data in a memory included in a memory system according to an embodiment of the present disclosure.

Referring to FIG. 2, a memory system 100 may compress at least a part of input data received from a host device 200 and store compressed data in a memory 110. When receiving a read request for data that is compressed and stored, the memory system 100 may decompress the compressed data and provide decompressed data to the host device 200.

Compression and decompression of data in the memory system 100 may be performed by, for example, a controller 120. In some embodiments, controlling data compression may be performed by a component other than the controller 120.

Depending on a request from the host device 200, the controller 120 may store input data in the memory 110 without compression, or may compress input data and store compressed data in the memory 110. The controller 120 may determine whether to compress input data using controller criteria. For example, on the basis of information such as the frequency of use of input data or the remaining capacity of the memory 110, the controller 120 may determine whether to store the input data as-is or to compress the input data and store compressed data.

The controller 120 may store compressed data and uncompressed data in the same storage region of the memory 110, or may store compressed data and uncompressed data in separate storage regions.

For example, the memory 110 may include a first storage region (SR1) 111 and a second storage region (SR2) 112. The first storage region 111 and the second storage region 112 may be physically separate regions or may be logically separate regions.

The controller 120 may store input data received from the host device 200 in the first storage region 111 of the memory 110 without compressing the input data. The controller 120 may compress input data received from the host device 200 and store compressed data in the second storage region 112 of the memory 110. When reading data stored in the second storage region 112, the controller 120 may decompress the corresponding data and then provide decompressed data to the host device 200.

The controller 120 may compress input data on the basis of various compression algorithms. For example, the controller 120 may compress input data on the basis of a compression algorithm such as the LZ4 algorithm or the ZSTD algorithm. Embodiments of the present disclosure describe a controller 120 that compresses input data on the basis of the LZ4 algorithm as an example, but other embodiments of the present disclosure are not limited thereto.

For example, the controller 120 may find data of a predetermined unit (e.g., 1 byte) in input data and convert the data in the predetermined units into compression format data. A compression format data of unit size converted by the controller 120 may be referred to as a sequence.

The controller 120 may identify a non-repetitive portion and a repetitive portion in input data, and may generate a sequence to include information indicating the repetitive portion. In the present specification, a non-repetitive portion may be referred to as a first data portion, and a repetitive portion may be referred to as a second data portion. The second data portion may be indicated by the information indicating the repetitive portion included in the sequence.

Since a repetitive portion of input data is indicated by the information indicating the repetitive portion included in the sequence, input data may be compressed by the difference between the size of data included in the sequence that indicates compression information and the size of data corresponding to the repetitive portion in the input data.

The controller 120 may generate a plurality of sequences by compressing input data. By storing, in the memory 110, a sequence that is a compressed form of input data, the controller 120 may store the input data in the compressed form in the memory 110.

When compressing input data, the controller 120 may perform compression in units of input data with a predetermined size. Input data with predetermined size may be referred to as unit input data.

When receiving input data, the controller 120 may perform compression on each unit input data. The size of unit input data may be, for example, 4 Kbytes, but embodiments of the present disclosure are not limited thereto.

The controller 120 may generate a sequence by performing compression on each unit input data of the predetermined size. Since the controller 120 performs compression in data units of the same size, compressed data may be generated without including information indicating the size of compressed input data or the like.

For example, referring to Case A of compressed data illustrated in FIG. 2, the controller 120 may generate compressed data including sequences that are generated by performing compression on each unit input data. Compressed data may be composed of only a plurality of sequences. In some embodiments, some compression-related information may be included in the front part or the rear part of compressed data, but compression information may not be included in each sequence. A sequence may be generated to include data and information regarding a non-repetitive portion and a repetitive portion in compressed data.

The controller 120 may generate compressed data to include compression-related information in addition to a sequence. Compression-related information included in compressed data may include information for improving compression or decompression performance.

For example, referring to Case B of compressed data illustrated in FIG. 2, compressed data may include at least one position information bit PI, which is located before a plurality of sequences. The position information bit PI may include information indicating a position corresponding to a preset size in compressed data.

When compressing input data, the lengths of respective sequences may not be constant. When the size of unit input data is 4 Kbytes, positions which are distinguished by the units of 1 Kbyte and 2 Kbytes may be indicated through position information bits PI. For example, the start positions of sequences seq1, seqP, seqQ and seqR may be indicated by position information bits P1, P2, P3 and P4, respectively. Unit input data may be divided by the unit of 1 Kbyte by using the position information bits PI.

During decompression, the controller 120 may perform decompression by identifying compressed data on the basis of a position indicated by the position information bit PI. Decompression on compressed data may be performed in parallel for a plurality of separate compressed data, thereby reducing the time required for decompression. Performance of providing compressed data by the memory system 100 may be improved.

In this way, the controller 120 may include some information related to compression or decompression at the front end (before a first sequence) or the rear end (after a last sequence) of compressed data. However, the controller 120 may configure compressed data only using sequences, thereby reducing the size of the compressed data and improving compression and decompression operations.

A sequence may have various structures depending on data that is compression target data, and may include data corresponding to a non-repetitive portion and information indicating a repetitive portion.

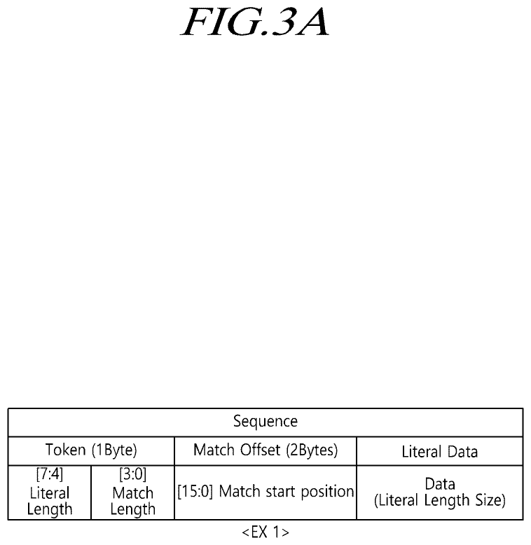

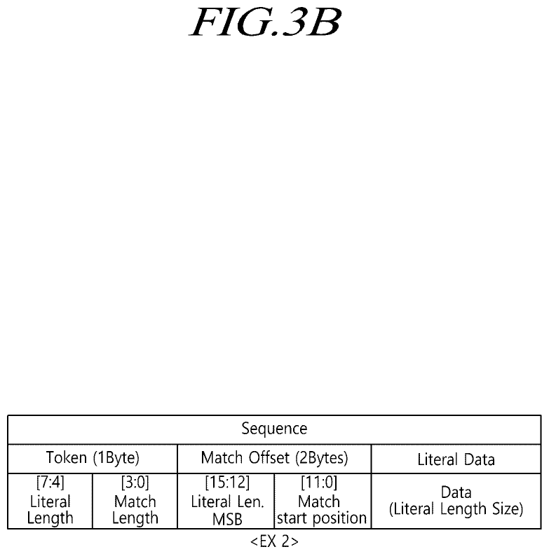

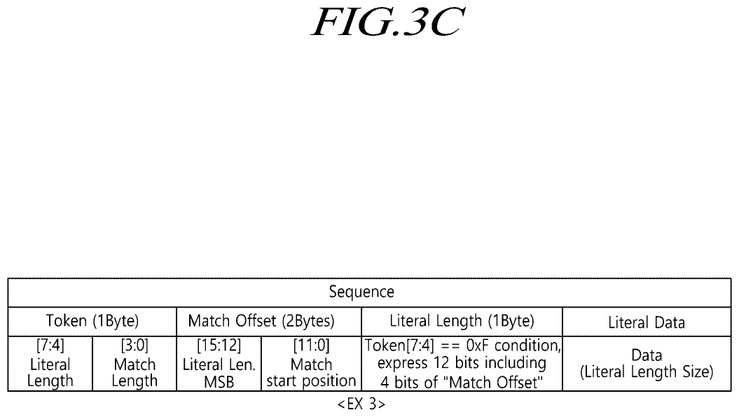

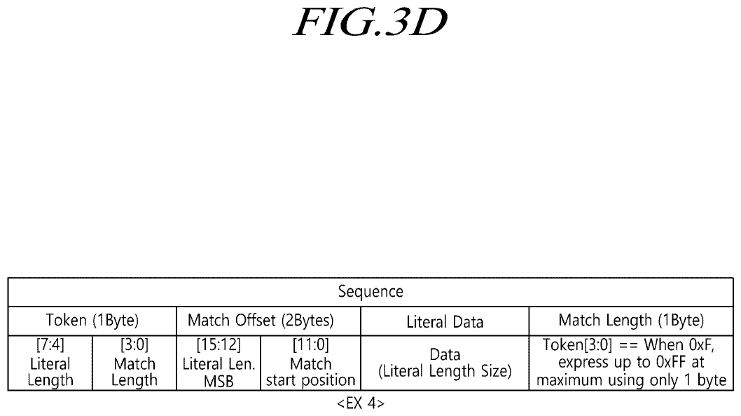

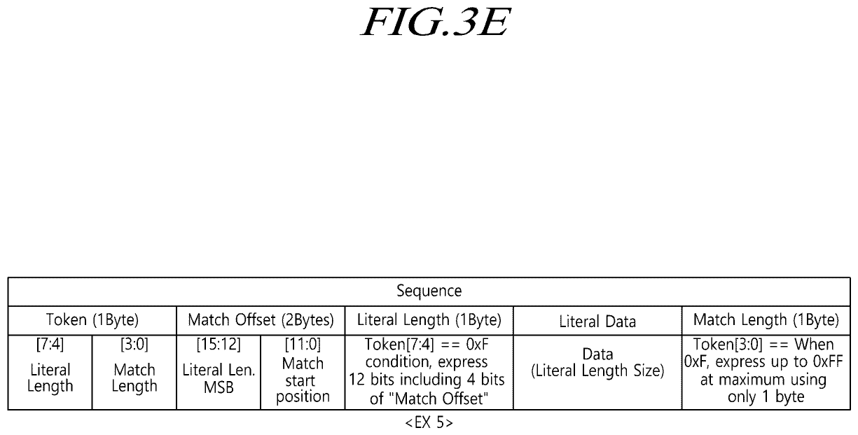

FIGS. 3A to 3E are diagrams illustrating examples of a format of compressed data stored in a memory of a memory system according to an embodiment of the present disclosure.

Referring to FIG. 3A, <EX 1> illustrates an example of a structure of a sequence. The sequence may include token bits, offset bits and a first data portion.

The token bits may include first token bits and second token bits. The number of bits of the token bits may be 1 byte, but embodiments are not limited thereto. Each of the first token bits and the second token bits may be composed of 4 bits.

The first token bits may include information indicating the length of the first data portion. The first data portion may mean a non-repetitive portion in input data. Through the first token bits of the sequence, the length of the first data portion corresponding to the sequence may be indicated.

The second token bits may include information indicating the length of a second data portion. The second data portion may mean a repetitive portion in the input data. Through the second token bits of the sequence, the length of the second data portion corresponding to the sequence may be indicated.

The offset bits may be consecutive to the token bits. The offset bits may include start position bits indicating the start position of repetitive data corresponding to the second data portion. The number of bits of the offset bits may be 2 bytes, but embodiments are not limited thereto. The token bits and the offset bits may be located at the front end of the sequence, and may be configured to have a fixed size.

The start position bits included in the offset bits may be composed of 16 bits. The start position of the repetitive data may be indicated using the start position bits. In a data portion as a compression target, the sequence may be generated without including the second data portion.

The first data portion may be located after the offset bits. The first data portion, which is a non-repetitive portion in compression target data, may be included in the sequence. Since the lengths of the first data portion and the second data portion are indicated by the token bits, and the start position of the repetitive data corresponding to the second data portion is indicated by the start position bits included in the offset bits, a sequence that is compressed to omit the second data portion and include the token bits and the offset bits may be generated.

The length of a first data portion or the length of a second data portion cannot be indicated by 4 bits, and for such a case, a sequence may further include auxiliary bits that are used to indicate the length of a data portion.

For example, referring to <EX 2> illustrated in FIG. 3B, a sequence may include token bits, offset bits and a first data portion. The token bits may include first token bits and second token bits. The offset bits may include auxiliary bits and start position bits.

For example, the auxiliary bits may be located between the second token bits and the start position bits. The number of bits of the auxiliary bits may be the same as the number of bits of the first token bits and the number of bits of the second token bits. The number of bits of the auxiliary bits may be smaller than the number of bits of the start position bits. For example, the auxiliary bits may be composed of 4 bits, and the start position bits may be composed of 12 bits.

Since the size of unit input data compressed into a plurality of sequences is fixed, by composing the start position bits included in the offset bits with 12 bits, the start position of repetitive data corresponding to a second data portion may be indicated. For example, when the number of bits of start position bits is N, the size of unit input data may be equal to or smaller than 2^{N} bytes, but embodiments are not limited thereto.

Since repetitive data may be indicated by composing start position bits with 12 bits, auxiliary bits that are used to indicate the length of a first data portion or the length of a second data portion may be composed using the 4 bits remaining in offset bits. The auxiliary bits may be used to indicate, for example, the length of the first data portion. When the size of the first token bits has a maximum value, information for indicating the length of the first data portion may be set through the auxiliary bits.

When the length of the first data portion may be indicated by the first token bits, that is, when the size of the first token bits is smaller than the maximum value, the value of the auxiliary bits may be 0. In a case where the length of the first data portion is not indicated by the first token bits, information that indicates the length of the first data portion may be set through the auxiliary bits.

Auxiliary bits may be set using bits other than bits for start position bits in offset bits. A sequence may be composed by adding bits that are used to indicate the length of a data portion.

For example, referring to <EX 3> illustrated in FIG. 3C, a sequence may include token bits, offset bits, first auxiliary bits and a first data portion.

The structures of the token bits and the offset bits may be the same as those in the example described above through FIG. 3B. The first auxiliary bits may be located between the offset bits and the first data portion.

The first auxiliary bits may be used to indicate, for example, the length of the first data portion. The number of bits of the first auxiliary bits may be 1 byte, but embodiments are not limited thereto.

The first auxiliary bits may be used together with auxiliary bits included in the offset bits, and may be used to indicate the length of the first data portion. For example, the auxiliary bits and the first auxiliary bits may be combined and used to indicate the length of the first data portion. When the first token bits are 0xF, 12 bits that are obtained as 4 bits of the auxiliary bits and 8 bits of the first auxiliary bits are combined and may be used to indicate the length of the first data portion.

Because the auxiliary bits may be upper bits, and the first auxiliary bits may be lower bits. The auxiliary bits may be referred to as first auxiliary upper bits, and the first auxiliary bits may be referred to as first auxiliary lower bits.

The sequence may include the token bits and the offset bits in a fixed form, and, as the occasion demands, may include the first auxiliary bits. When the sequence includes the first auxiliary bits, the size of the first data portion included in the sequence may be equal to or larger than a preselected size.

For example, as in the examples illustrated in FIGS. 3A and 3B, when the length of the first data portion is indicated by the first token bits or the auxiliary bits, the size (or length) of the first data portion may be 1 to 14 bytes. As in the example illustrated in FIG. 3C, when the first auxiliary bits are further included between the offset bits and the first data portion to indicate the length of the first data portion, the size (or length) of the first data portion may be equal to or larger than 15 bytes, but embodiments are not limited thereto.

A sequence may include second auxiliary bits, which are used to indicate the size of repetitive data corresponding to a second data portion.

For example, referring to <EX 4> illustrated in FIG. 3D, a sequence may include token bits, offset bits, a first data portion and second auxiliary bits. The token bits may include first token bits and second token bits. The offset bits may include auxiliary bits and start position bits. Since first auxiliary bits are not included in the sequence, the size (or length) of the first data portion may be equal or smaller than the preselected size (e.g., 1 to 14 bytes).

The second auxiliary bits, which are consecutive to the first data portion, may be used to indicate the length of a second data portion.

For example, when the second token bits are 0xF, the second auxiliary bits may be included in the sequence by being set with information for indicating the length of the second data portion. The number of bits of the second auxiliary bits may be the same as the number of bits of the token bits. The number of bits of the second auxiliary bits may be equal to or greater than the number of bits of the auxiliary bits. The second auxiliary bits may be composed of 8 bits, but embodiments of the present disclosure are not limited thereto.

In addition, a sequence may include both first auxiliary bits and second auxiliary bits.

For example, referring to <EX 5> illustrated in FIG. 3E, a sequence may include token bits, offset bits, first auxiliary bits, a first data portion and second auxiliary bits.

The respective sections included in the sequence may include information described through the above examples. Since the front part of the sequence is composed of the token bits and the offset bits to have a fixed form, recognition is facilitated when performing compression and decompression. Since bits other than start position bits in offset bits are set as auxiliary bits, the length of a first data portion with a size equal to or smaller than a preselected size may be indicated without adding first auxiliary bits for indicating the length of the first data portion.

Depending on the length of a first data portion or the length of a second data portion, a sequence may be composed by adding first auxiliary bits or second auxiliary bits, so that it may also be possible to indicate when the length of the first data portion or the length of the second data portion is equal to or larger than a preselected size.

By limiting each of the numbers of bits of the first auxiliary bits and the second auxiliary bits to, for example, 1 byte, a sequence with a form in which input data is compressed may be configured by being simplified. Compressed data composed of a plurality of sequences may be efficiently generated, and it is possible to improve the efficiency of storing compressed data in the memory 110 and the performance of compression and decompression operations.

The compression operation of generating a sequence and the operation of decompressing the sequence and providing input data may be performed, for example, by a controller 120.

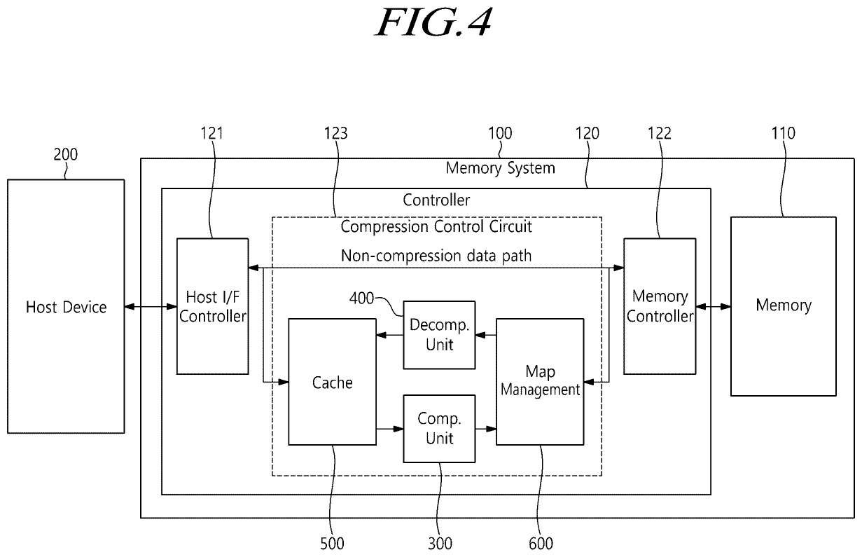

FIG. 4 is a diagram illustrating an example of a configuration of a controller 120 included in a memory system according to an embodiment of the present disclosure.

Referring to FIG. 4, a controller 120 of a memory system 100 may include a first controller 121, a second controller 122 and a compression control circuit 123.

The first controller 121 may communicate with the host device 200, and may be referred to as a host interface controller. The first controller 121 may transfer a command and input data received from the host device 200 to the compression control circuit 123.

The second controller 122 may communicate with the memory 110. The second controller 122 may be referred to as a memory controller. According to a command, the second controller 122 may control an operation of writing data to the memory 110 or control an operation of reading data stored in the memory 110.

The compression control circuit 123 may control overall operations related with compression performed by the controller 120. The compression control circuit 123 may mean a circuit or a configuration corresponding to a function related with a compression operation among various functions of the controller 120.

Depending on input data and a command, the compression control circuit 123 may store the input data in the memory 110 without compressing the input data. The input data may be transferred through a path between the first controller 121 and the second controller 122.

Depending on input data and a command, the compression control circuit 123 may compress the input data and store compressed data in the memory 110, or may decompress compressed data stored in the memory 110 and provide decompressed data to the host device 200.

The compression control circuit 123 may include, for example, a compression unit 300, a decompression unit 400, a cache 500 and a map management unit 600.

The compression unit 300 may compress input data received from the host device 200 to generate compressed data. The compression unit 300 may generate a plurality of sequences for each unit input data of a predetermined size and generate compressed data including the plurality of sequences.

The decompression unit 400 may decompress, according to a request of the host device 200, compressed data stored in the memory 110. The decompression unit 400 may provide decompressed data to the host device 200 through the first controller 121.

The cache 500 may temporarily store input data to be compressed by the compression unit 300 or data decompressed by the decompression unit 400. The map management unit 600 may manage mapping information between a logical address associated with compressed data and a physical address of the memory 110. Due to compression of input data received from the host device 200, the size of the input data and the size of compressed data may be different. The map management unit 600 may manage the mapping relationship between a logical address by the host device 200 and a physical address of the memory 110 where compressed data is stored, and may provide mapping information when writing and reading compressed data.

The compression unit 300 and the decompression unit 400 may include at least one processor. By the at least one processor, a compression operation and a decompression operation may be performed. In order to reduce delay in the process of storing compressed data in the memory 110 and reading compressed data stored in the memory 110, a compression operation or a decompression operation may be performed by a plurality of processors.

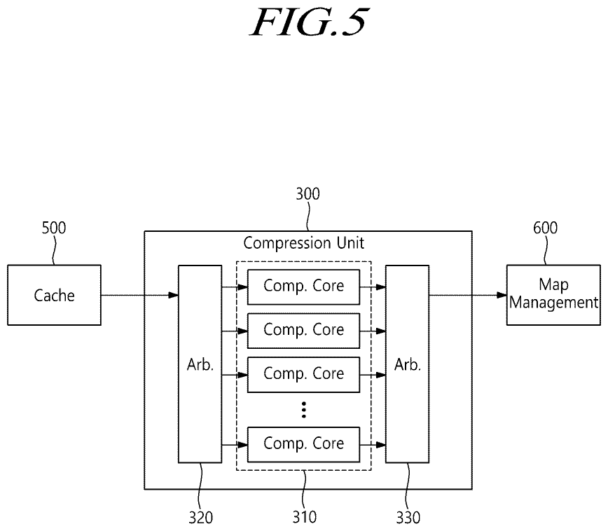

FIGS. 5 to 7 are diagrams illustrating examples of the structure of compression units included in controllers according to embodiments of the present disclosure.

Referring to FIG. 5, a compression unit 300 may include, for example, a plurality of compression core processors 310.

A first compression arbiter 320 of the compression unit 300 may receive input data from the cache 500 and distribute and transfer the received input data to the plurality of compression core processors 310. Input data transferred to each of the plurality of compression core processors 310 may be transferred according to the size of unit input data.

Each of the plurality of compression core processors 310 may convert received unit input data into compressed data including a plurality of sequences. The compressed data converted by each of the plurality of compression core processors 310 may be transferred to the map management unit 600 by a second compression arbiter 330.

Since conversion of unit input data is performed in parallel by the plurality of compression core processors 310, a time required for compression of input data may be reduced. In addition, since compressed data is converted into a form including the sequences described above with reference to FIGS. 3A to 3E, the conversion efficiency of the compressed data may be improved.

By providing compressed data composed of a plurality of sequences, the compression efficiency and the storage efficiency of the compressed data may be increased, and, since compression by the plurality of compression core processors 310 is performed for respective unit input data, the operational performance of the memory system 100 may be improved while efficiently using the storage space of the memory 110 according to compression of data to be stored in the memory 110.

The configuration of each of the plurality of compression core processors 310 may be implemented in various ways.

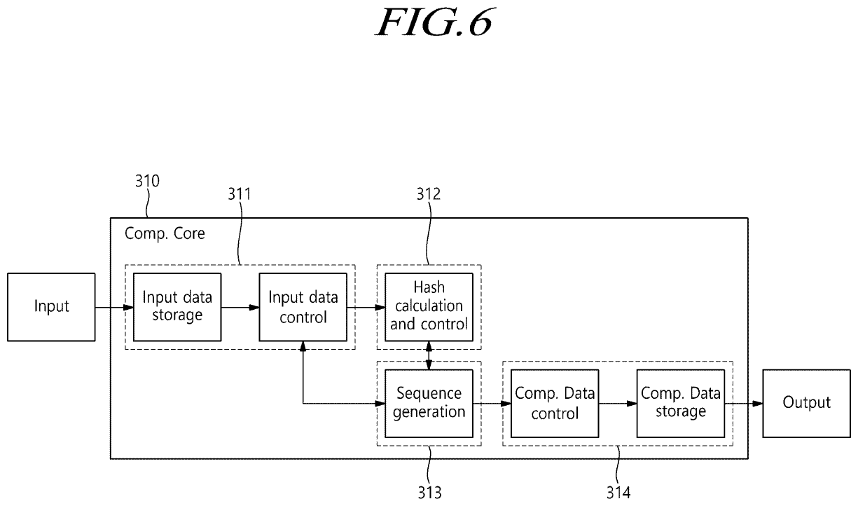

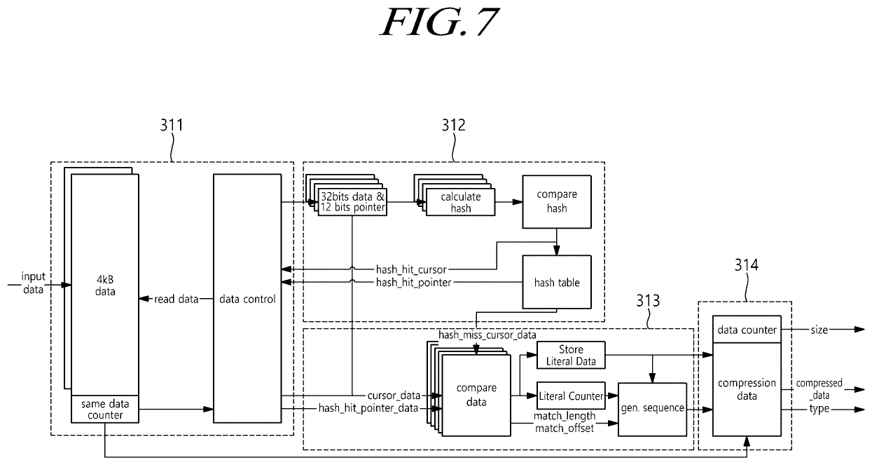

For example, referring to FIGS. 6 and 7, each of the plurality of compression core processors 310 may include an input data processing section 311, a hash control section 312, a sequence generating section 313 and a compressed data output section 314.

The input data processing section 311 may store input data received from the host device 200 and control the input data in the process of converting the input data into sequences. For example, the input data processing section 311 may include a plurality of input buffers (e.g., two input buffers) each of which stores unit input data, so that compression operations are continuously performed. In addition, the input data processing section 311 may include a counter, which counts the number of first input data, so that unit input data is continuously processed.

The hash control section 312 may obtain a plurality of hashes on the basis of input data received from the input data processing section 311 and, through comparison of the plurality of hashes, may identify repetitive data corresponding to a repetitive portion in the input data. For example, when a hash hit occurs, the hash control section 312 may transfer information on the hash hit to the input data processing section 311. When a hash miss occurs, the hash control section 312 may transfer information on the hash miss to the sequence generating section 313.

The sequence generating section 313 may generate a sequence on the basis of information received from the input data processing section 311 and information received from the hash control section 312. The sequence generating section 313 may identify a non-repetitive portion and a repetitive portion in the input data on the basis of results of hash hits and hash misses, and may include the non-repetitive portion as a first data portion of the sequence. The sequence generating section 313 may generate the sequence to include bits indicating information related with the non-repetitive portion and the repetitive portion.

The compressed data output section 314 may output compressed data composed of sequences generated by the sequence generating section 313. The compressed data output section 314 may output information on the size or type of the compressed data. The compressed data outputted by the compressed data output section 314 may be transferred to and stored in the memory 110.

The compressed data stored in the memory 110 may be provided to the host device 200 after being decompressed according to a request of the host device 200. The decompression unit 400, which performs decompression of compressed data, may also perform decompression using a plurality of processors similar to that of the compression unit 300.

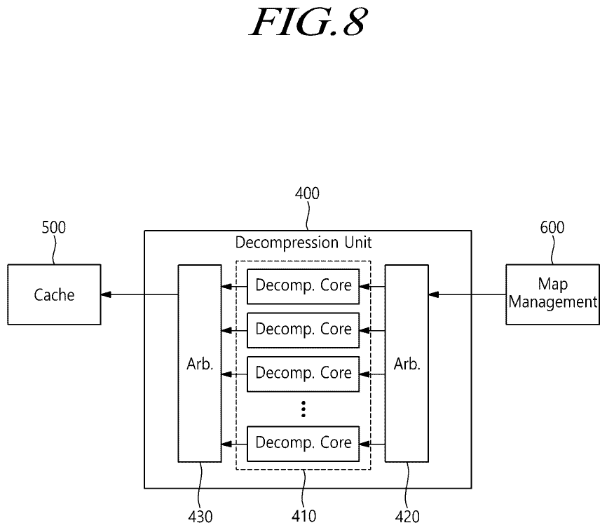

FIGS. 8 to 10 are diagrams illustrating an example of the structure of a decompression unit included in a controller according to an embodiment of the present disclosure.

Referring to FIG. 8, a decompression unit 400 may include, for example, a plurality of decompression core processors 410.

A first decompression arbiter 420 of the decompression unit 400 may receive compressed data read from a memory 110 on the basis of mapping information of a map management unit 600, and may distribute and transfer the received compressed data to a plurality of decompression core processors 410.

Each of the plurality of decompression core processors 410 may decompress received compressed data, and may transfer decompressed data to a cache 500 through a second decompression arbiter 430. Decompressed data stored in the cache 500 may be provided to the host device 200 through the first controller 121.

Each of the plurality of decompression core processors 410 may receive compressed data of a predetermined size and perform a decompression operation. The configuration of each of the plurality of decompression core processors 410 may be implemented in various ways.

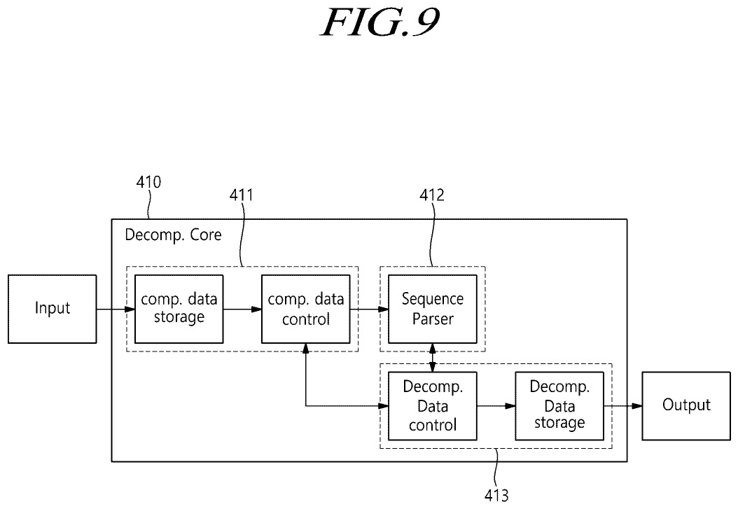

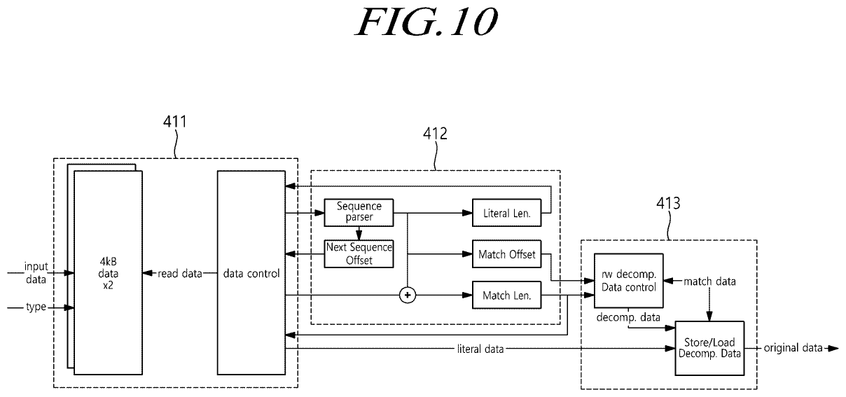

For example, referring to FIGS. 9 and 10, each of the plurality of decompression core processors 410 may include a compressed data control section 411, a sequence analysis section 412 and a decompressed data output section 413.

The compressed data control section 411 may receive and store compressed data stored in the memory 110 in units of a predetermined size. The compressed data control section 411 may provide the compressed data to the sequence analysis section 412, and may receive a result according to the analysis of the sequence analysis section 412. For example, the compressed data control section 411 may include a plurality of input buffers so that a decompression operation is performed while compressed data for decompression is continuously received.

The sequence analysis section 412 may divide a first data portion and a second data portion corresponding to a sequence by using a sequence parser. For example, the sequence analysis section 412 may transfer the first data portion corresponding to a non-repetitive portion in the compressed data to the compressed data control section 411. The sequence analysis section 412 may transfer information associated with the second data portion corresponding to a repetitive portion to the decompressed data output section 413.

The decompressed data output section 413 may receive and store the first data portion and the second data portion based on the sequence. The decompressed data output section 413 may generate decompressed data on the basis of the first data portion and the second data portion. The decompressed data output section 413 may transfer the decompressed data to the host device 200. Start position bits indicating the start position of repetitive data corresponding to a second data portion in a sequence may be compressed as an absolute position rather than a relative position, so that information on a start position where the decompressed second data portion is positioned may be processed first.

Since decompression of compressed data is performed in parallel by the plurality of decompression core processors 410, the efficiency of a decompression operation may be improved.

In addition, when compressed data includes position information bits, the compressed data may be simultaneously decompressed by being divided into a plurality of pieces on the basis of the position information bits. For example, when compressed data includes two position information bits, a first portion indicated by a first position information bit and a second portion indicated by a second position information bit may be divided and decompressed simultaneously. By reducing a time required for decompressing compressed data, delays when reading compressed data stored in the memory 110 may be reduced.

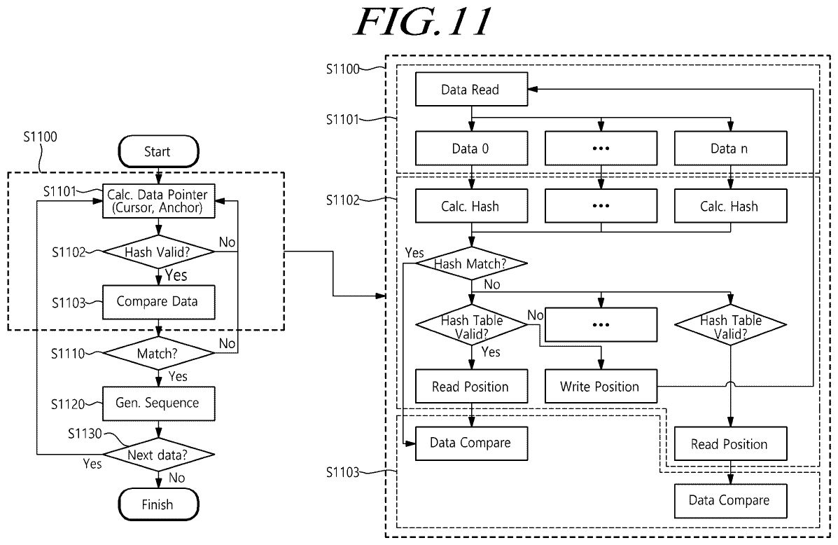

FIG. 11 is a diagram illustrating an example of a method in which a memory system compresses input data to generate compressed data according to embodiments of the present disclosure.

Referring to FIG. 11, a controller 120 of a memory system 100 may perform an operation of comparing repetitive portions in input data to compress the input data (S1100).

The controller 120 may read the input data and divide the input data so that hash calculations for the input data may be processed in parallel (S1101).

The controller 120 may check whether hashes for divided input data are valid (S1102). The controller 120 may calculate the hashes for the divided input data and check whether the hashes match. When the hashes do not match, the controller 120 may check whether a hash table is valid.

When the hashes match, the controller 120 may compare input data (S1103). In addition, when the hashes do not match and the hash table is valid, the controller 120 may compare input data.

The controller 120 may check whether compared input data matches a repetitive portion (S1110). When the compared input data matches the repetitive portion, the controller 120 may generate a sequence (S1120). When the compared input data does not match the repetitive portion, the controller 120 may repeatedly perform the operation of reading input data, checking whether hashes are valid and comparing input data.

The controller 120 may check whether next data exists (S1130). When next data exists, the controller 120 may repeatedly perform the operation of comparing input data, and when next data does not exist, the controller 120 may finish a compression operation.

According to embodiments of the present disclosure, by compressing input data by units of a predetermined size and configuring compressed data only using sequences, the compression efficiency of the input data may be improved. In addition, by performing a compression operation and a decompression operation in parallel using a plurality of processors, delays due to compression and decompression of input data to be stored in the memory may be reduced.

By storing compressed data in the memory, the storage space of the memory may be efficiently used, and, through the structure of a compression format and parallel processing of compression and decompression operations, the performance of the memory system that supports a compression function may be improved.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A memory system comprising:
at least one memory; and
a controller configured to receive input data from an external device, to compress at least a part of the input data to generate compressed data including a plurality of sequences, and to store the compressed data in the at least one memory,
wherein each of the plurality of sequences includes token bits that correspond to a first data portion and a second data portion, the token bits including first token bits indicating a length of the first data portion and second token bits indicating a length of the second data portion; offset bits that include start position bits indicating a start position of repetitive data corresponding to the second data portion; and the first data portion, which is positioned next the offset bits.

2. The memory system according to claim 1, wherein each of the plurality of sequences includes auxiliary bits that are included in the offset bits and that are located between the token bits and the start position bits of the offset bits.

3. The memory system according to claim 2, wherein the number of bits of the auxiliary bits is smaller than the number of bits of the start position bits.

4. The memory system according to claim 2, wherein the auxiliary bits are used to indicate the length of the first data portion.

5. The memory system according to claim 2, wherein at least one of the plurality of sequences includes first auxiliary bits that are located between the offset bits and the first data portion and that are used to indicate the length of the first data portion.

6. The memory system according to claim 5, wherein the number of bits of the first auxiliary bits is greater than the number of bits of the auxiliary bits.

7. The memory system according to claim 5, wherein the auxiliary bits and the first auxiliary bits are combined and used to indicate the length of the first data portion, and the auxiliary bits are upper bits and the first auxiliary bits are lower bits.

8. The memory system according to claim 5, wherein at least one of the plurality of sequences includes second auxiliary bits that are used to indicate the length of the second data portion, and have the same number of bits as the number of bits of the first auxiliary bits.

9. The memory system according to claim 1, wherein at least one of the plurality of sequences includes second auxiliary bits that are used to indicate the length of the second data portion.

10. The memory system according to claim 9, wherein the number of bits of the second auxiliary bits is the same as the number of bits of the token bits.

11. The memory system according to claim 1, wherein in each of the plurality of sequences, a sum of the number of bits of the token bits and the number of bits of the offset bits is constant.

12. The memory system according to claim 1, wherein the number of bits of the start position bits is N (where N is an integer satisfying N≥2), and a size of unit input data to be compressed into the compressed data is equal to or smaller than 2^{N} bytes.

13. The memory system according to claim 1, wherein
the compressed data includes at least one position information bit that is located before the plurality of sequences, and
the controller divides, when decompressing the compressed data, the compressed data using the at least one position information bit, and decompresses divided compressed data in parallel.

14. A control device comprising:
a first controller configured to communicate with a host device;
a second controller configured to communicate with a memory device; and
a compression control circuit configured to compress at least a part of input data received from the host device to generate compressed data to be stored in the memory device, the compressed data including a plurality of sequences,
wherein each of the plurality of sequences includes first token bits that correspond to a first data portion and indicate a length of the first data portion; second token bits that correspond to a second data portion and indicate a length of the second data portion; first auxiliary upper bits that are used to indicate the length of the first data portion; start position bits that indicate a start position of repetitive data corresponding to the second data portion; and the first data portion, which is located next the start position bits.

15. The control device according to claim 14, wherein the number of bits of the first token bits, the number of bits of the second token bits and the number of bits of the first auxiliary upper bits are the same.

16. The control device according to claim 14, wherein the number of bits of the start position bits is greater than the number of bits of the first auxiliary upper bits.

17. The control device according to claim 14, wherein at least one of the plurality of sequences includes first auxiliary lower bits that are located between the start position bits and the first data portion, have the number of bits greater than the number of bits of the first auxiliary upper bits, and are used to indicate the length of the first data portion together with the first auxiliary upper bits.

18. The control device according to claim 17, wherein at least one of the plurality of sequences includes second auxiliary bits that are located next the first data portion, have the number of bits the same as the number of bits of the first auxiliary lower bits, and are used to indicate the length of the second data portion.

19. A memory device comprising:
a first storage region for storing uncompressed data from a host device; and
a second storage region for storing compressed data from the host device,
wherein the compressed data includes a plurality of sequences, and
wherein each of the plurality of sequences includes first token bits that indicate a length of a first data portion; second token bits that indicate a length of a second data portion; start position bits that indicate a start position of repetitive data corresponding to the second data portion; and the first data portion, and
wherein the start position bits are located between the second token bits and the first data portion.

20. The memory device according to claim 19, wherein at least one of the plurality of sequences includes auxiliary bits that are located between the second token bits and the start position bits, the number of bits of the auxiliary bits is the same as the number of bits of the second token bits.
